(19) United States
(12) Patent Application Publication
(10) Pub. No.: US 2014/0342795 A1
(43) Pub. Date: Nov. 20, 2014

(54) Live streaming video lottery to present winner reaction

(71) Applicant: James Zalcman, Boston, MA (US)

(72) Inventor: James Zalcman, Boston, MA (US)

(73) Assignee: C-Win Technologies LLC

(21) Appl. No.: 13/986,533

(22) Filed: May 14, 2013

(51) Int. Cl. G07F 17/32

(52) U.S. Cl. CPC G07F 17/329
USPC 463/17

(57) ABSTRACT

This invention provides live transmission of video feeds from players to a central server over the Internet, with the players' images being portrayed to all of the participants by a reverse video feed. The winner of a particular game is indicated by indicia surrounding the image of the winning individual, with the reaction of the individual having been apprised of his winning the game being transmitted to all other participants through a live streaming video on the Internet back to all the players of the game.

### FIELD OF THE INVENTION

This invention relates to live, on-line gaming contests and more particularly to a method and apparatus for presenting player reaction to winning.

### BACKGROUND OF THE INVENTION

As will be appreciated, there have been a large number of lottery systems in which contestants or players pick numbers which if they match a winning number result in the payout of a jackpot to the player who picked the winning number. Such games typically are the type of KENO games available in bars and restaurants in which a player buys certain numbers, with the play usually taking somewhere between 30 and 45 seconds.

The largest problem in the lottery industry is that there is a dearth of players in the 18-35 year old demographic, the so-called millennials. This lack of interest has provided an opportunity to create a game that will encourage participation of this millennial demographic.

The lottery games so far result in boredom to players who gravitate to on-line games and require media satisfaction. Moreover, the millennial players prefer that a game take place within a communal experience, a situation currently not available to the lottery industry.

In short, with the current lottery games one chooses a number which is the end of the active participation of the player. As a result there is no eliciting of a response of a player which is shared within the community and this void deprives the lottery participants with a level of entertainment.

There is therefore a necessity, especially for Internet lottery types of games, to bring the excitement of a live event to the on-line experience. Thus, there is a need in the lottery industry to make it a live experience, thus to increase the enjoyment of the game and to increase participation.

By way of further background and as illustrated in U.S. Patent Publication number 2011/0237318 a system is provided for a game show which may be played on-line in which the participants in the game show are Internet users who may use a web camera to connect to the on-line game. In this particular type of game the players are asked questions and if they answer correctly, they are allowed to stay in the game, whereas if they fail to answer correctly they are removed from the game. This game is characterized as being a last cam standing game.

The problem with such a game is that while the contestants transmit web camera images to a central server, with the web images being shown at each of the individual's terminals, there is no display of the individual's reaction to winning based on an on-screen indication of the winner to not only the winning player but also to all of the rest of the players. The result is that for this type of quiz show gaming experience the reaction of a player to winning is not featured in the game space, and the possibility of providing additional excitement to the game is not present. In the above-described game, the winner is only indicated by the removal of the video feeds for those who cannot answer questions correctly. Thus, there is no positive indication to the winner and the winner has in fact won the game much less an opportunity for the winner to display his emotions or response to winning to all of the on-line players especially at the exact moment when the winner is first advised that he or she has won the game.

In this respect it will be appreciated that there is no filming of the reaction to winning based on indicia sent to the winner over the Internet and displayed in a winner's window or game space. Moreover, nowhere is shown the ability to increase the number of participants by stacking and randomly displaying images of players in a given window which would multiply the number of players that can play. In short, there is no stacking of players to be placed in a window and no random selection of players to be displayed in a given window.

Further, nowhere in this reference is shown the ability of a player or a participant to select the window in which he or she is to be shown or presented, since this is not part of the game.

Most importantly, this reference teaches a game of skill versus games of chance in which winning is randomly selected. Thus, this reference does not relate to lottery type games.

### SUMMARY OF INVENTION

In an Internet lotto game, each of the players or contestants provides a web camera live video feed of his or her face over the Internet to a central server which in turn distributes all of the received video feeds to all of the participants in the game. This is done in a game space in which each of the participants has his or her face shown in a window on his or her computer screen.

In one embodiment, each of the players provides a number which if matched causes his or her video feed to indicate that he or she is the winner of a particular round of the game, with a visual indicator surrounding the image of the winning person's face. At the instant that the winner receives notification by this method that he or she is a winner, the excitement of the winner is transmitted to all of the other players who are playing the game, thus to simulate a live audience excitement and thus increase the desirability of playing the Internet lotto game.

In a preferred embodiment, a winner is selected when music playing during a round stops, very much in the same manner as musical chairs. The winner is selected using a random number generator to randomly select the time when the music stops. This in turn randomly selects the winner.

Thus, when the live video feeds of the participants or players are shown in their respective windows, the live video presented when the music stops designates the winner, with the live video feed continuing after the winner has been told that he or she is the winner. This evokes an emotional response which is transmitted by live video feed to all participants or players.

More particularly, in one embodiment, each player designates a number for a window that he or she desires to be located in, for instance, in the simplest case one of five windows. The windows are activated in a manner equivalent to musical chairs by indicia surrounding the activated window. Music is played such that when the music stops the window that is activated at the time the music stops indicates the winner for the particular round of the lottery game. At the time the music stops, the winner is indicated in one embodiment by visual indicia surrounding the winner's window which indicates to all the participants who the winner of the round is along with a video feed from the winner indicating his or her excitement on having won.

This display of the excitement of the particular winner is an increased inducement to play the lotto game and will appeal to the millennial demographic so as to create for a lottery game a communal experience that is attractive to those who play communal games on the Internet.

In a preferred embodiment once the number of players for a particular round have been ascertained a winner is preselected by selecting the window number that will be activated at the time the music stops. This selection of the window number and thus the winner for the round of the lotto game is controlled in one embodiment by a random number generator.

The lottery game may include for instance three rounds in which the winner of the jackpot must choose the correct window for each round, with the person selecting the correct window for each round winning the jackpot round.

While the above has been described in connection with a number of players limited to the number of windows in which live streaming exists, it is possible to increase the number of players by providing video for a particular window from all players who have selected that window with the video feeds for a window being sequentially activated. Thus, as a further level of complexity, the video for a given window comes from a number of players with the player winning being the one whose video stream is active at the exact moment that the music stops. This window then provides a view of the winning player.

Thus, in addition to using a random number generator to generate when for instance a player is selected as the winning player in a musical chairs type of environment, for the window that is selected there is a further random number selected video feed for players who have selected that particular window as their window for the round.

When there are more than one player to be portrayed in a given window, the video feed from all the players of that window is multiplexed in such a way that video for each of the players is presented on-screen for, for instance, for a number of milliseconds. Thus, for each window the number of players who have selected that window are cycled through such that when the music stops and the window is selected as the winning window, that player whose video feed is currently being displayed is declared the winner. Thus, the number of players that may be permitted to enter the game may be increased by the number video feeds allowed for the given window over a given period of time.

In summary, this invention provides live transmission of video feeds from players to a central server over the Internet, with the players' images being portrayed to all of the participants by a reverse video feed. The winner of a particular game is indicated by indicia surrounding the image of the winning individual, with the reaction of the individual having been apprised of his winning the game being transmitted to all other participants through a live streaming video on the Internet back to all the players of the game.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the selection of a winner in an Internet gaming scenario in which the winner is connected through the Internet to all the other participants such that a webcam at the winner's location broadcasts the winner's reaction to winning the game to all the participants;

FIGS. 2A-2I show one round of a lottery game in which windows are displayed carrying video images of participants assigned to a window, in which window selection is controlled such that in a given moment of time a window is selected to indicate the winner of the game, with the image of the game winner being provided to all the participants;

FIGS. 3A-3G illustrate round 2 of the game of FIGS. 2A-2I illustrating the reaction of the winner of round 2 which is broadcast to all the participants over the Internet;

FIGS. 4A-4G illustrate the jackpot round of the game of FIGS. 2A-2I and 3A-3G, illustrating the anticipation of the winning of the jackpot, followed by the reaction of the winner of the jackpot;

FIGS. 5A-5F are flowcharts showing the operation of a lottery game involving the selection of a winner through the selection of a window and the streaming video of the image of the winner in the selected window upon the winner having been selected by the game; and

FIG. 6 is a diagrammatic representation of the random multiplexing of video streams to be presented in a window.

### DETAILED DESCRIPTION

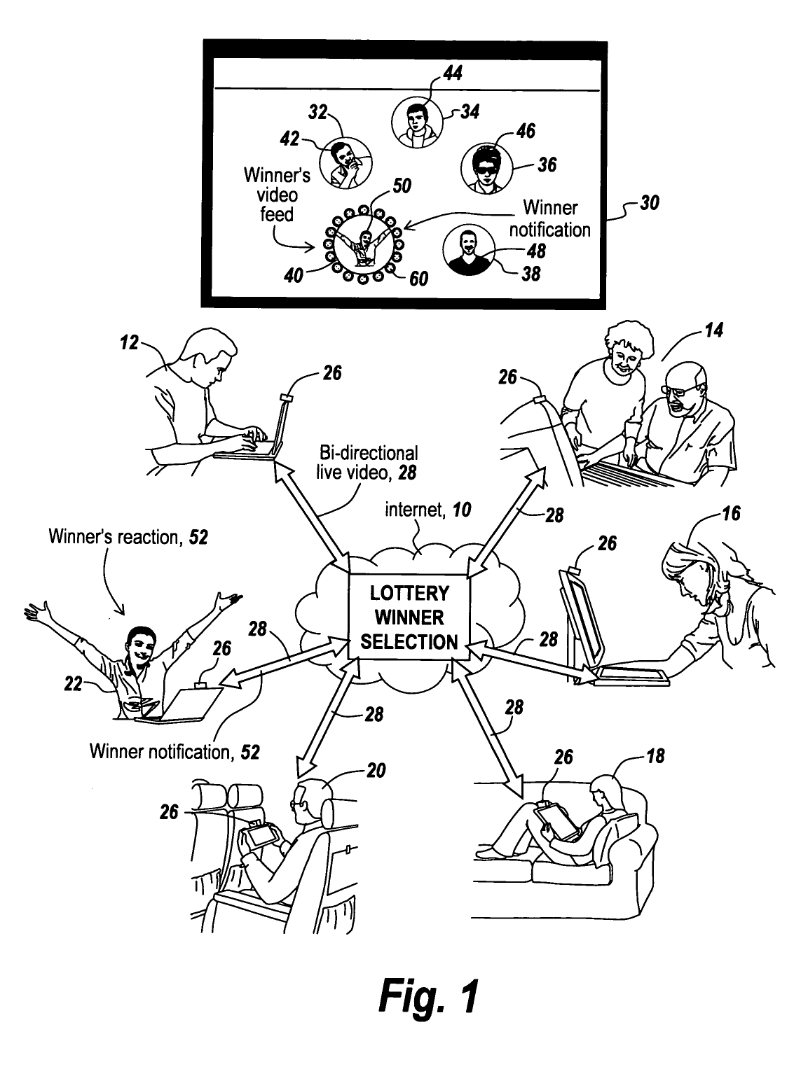

Referring now to FIG. 1, the Internet 10 is utilized to connect participants 12, 14, 16, 18, 20 and 22 to the lottery winning selection server 24, with the individual computers of the participants being coupled by the Internet over bi-directional video links 28 to connect video cameras 26 at each of the participant's computers to lottery winner selection server 24.

It will be appreciated that each of the participants has a computer with a computer screen such as that illustrated at 30 in which each of the windows 32, 34, 36, 38 and 40 provided for game play are provided with respective video screen images such as shown at 42, 44, 46, 48 and 50 such that at each of the participant's computers all of the participants are shown on the respective computer screens.

When lottery winner selection server 24 selects a lottery winner, in one embodiment it selects a window and notifies the winner as illustrated at 52 that he is the winner, such that on the computer screen of the winner is shown indicia 60 to indicate to all the participants which of the windows has been selected as the winner's window. Note all video streams are presented to all participants in the associated window. Here it can be seen that the image 50 of winner 22 shows the winner's reaction to having been selected as a winner, with all of the raw emotions being viewable by all participants at the exact instant that the winner is selected.

It will be appreciated that the winner is alerted to the fact that his window has been selected through indicia 60 which in turn gives rise to the winner's emotional reaction to having been selected as the winner.

While the winner selection system for any game may vary, in particular as regards to subject invention the lottery system is one in which the winner is selected by activating a winner's window.

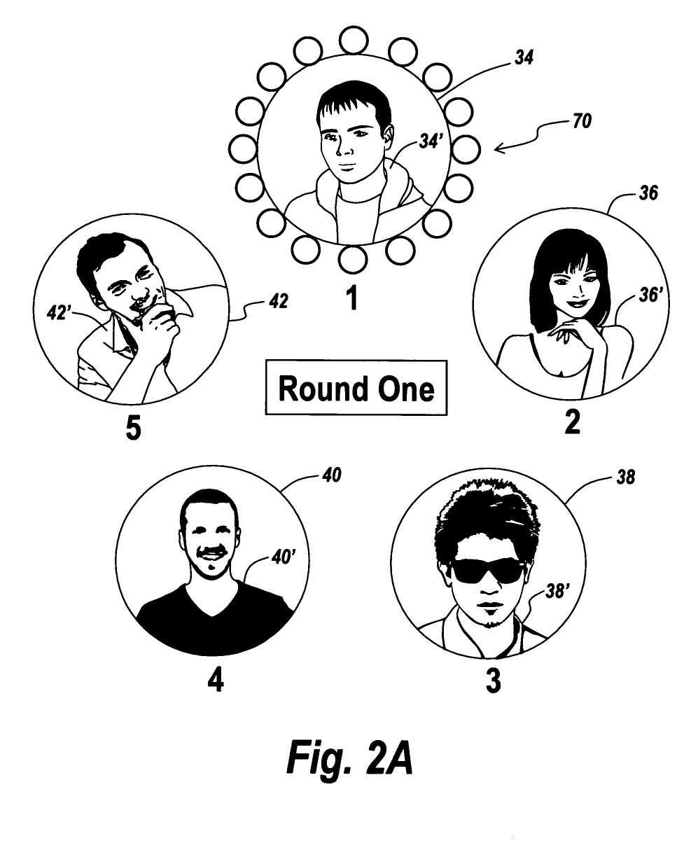

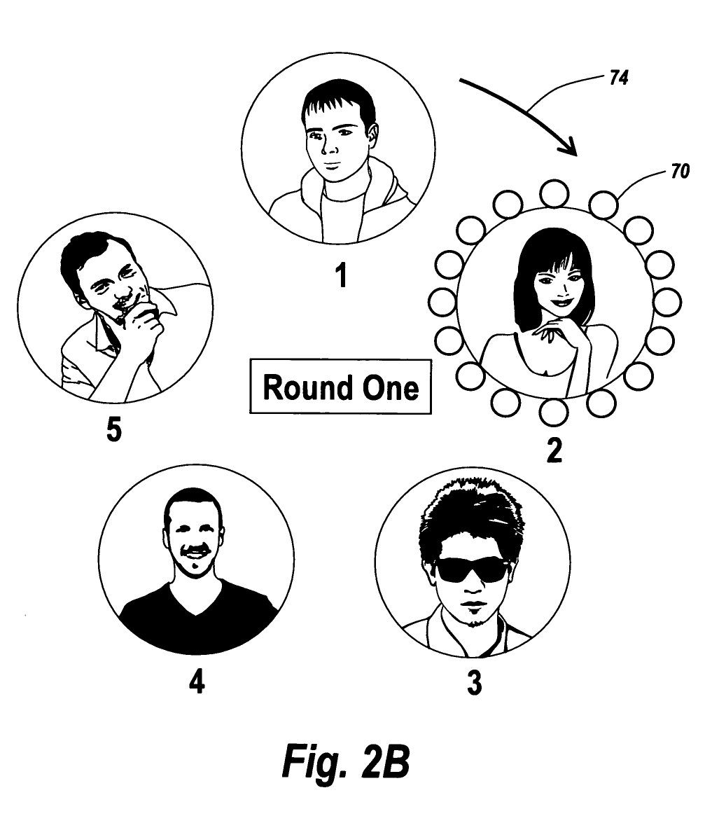

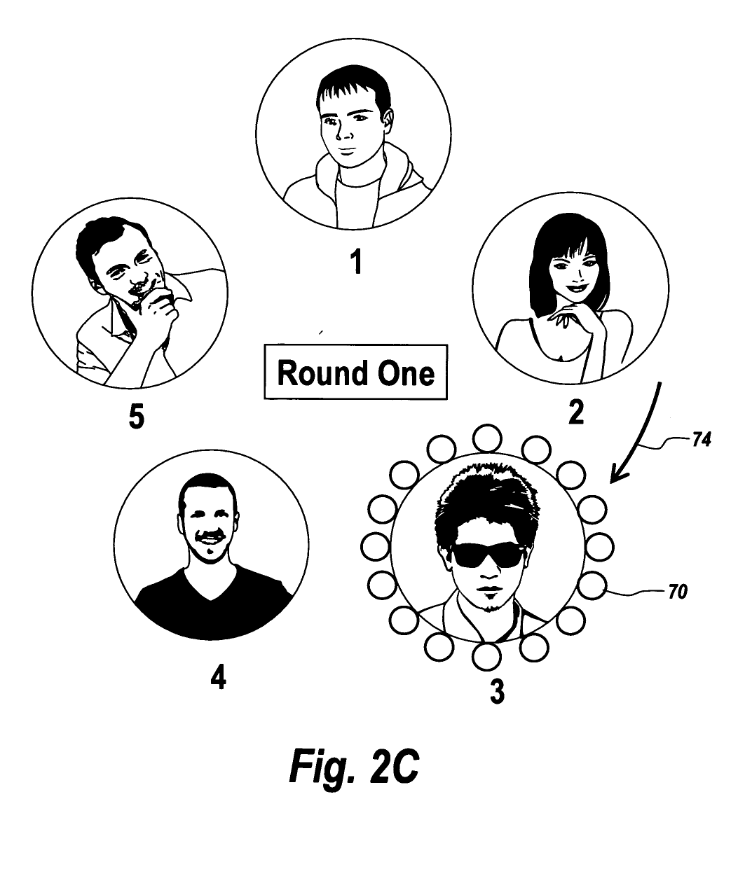

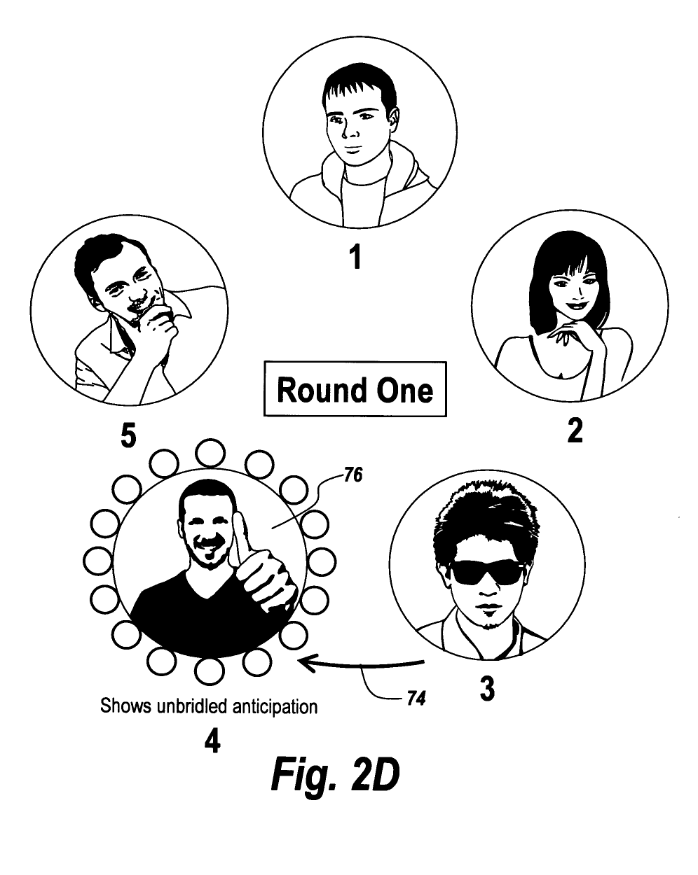

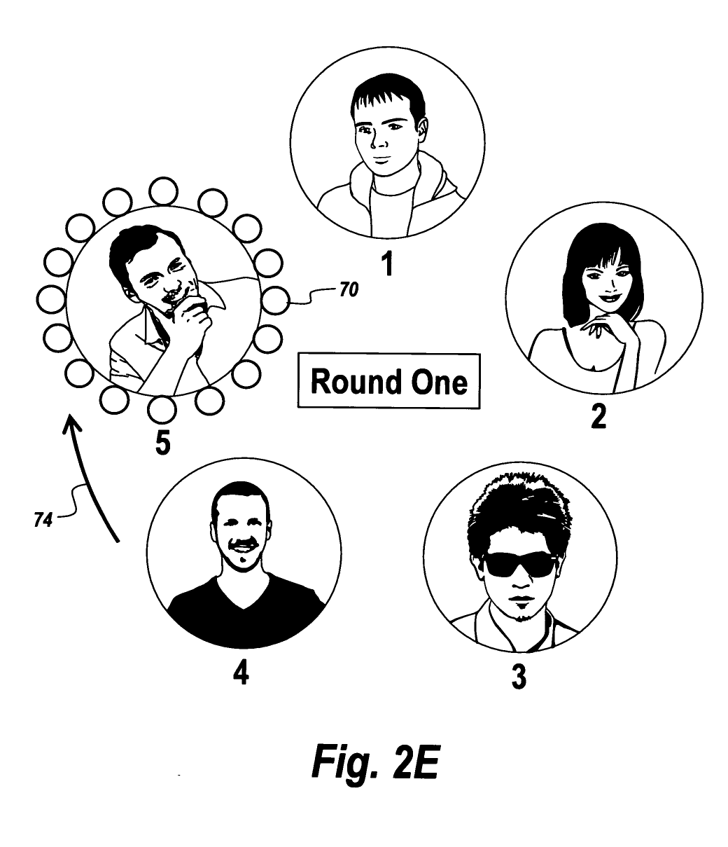

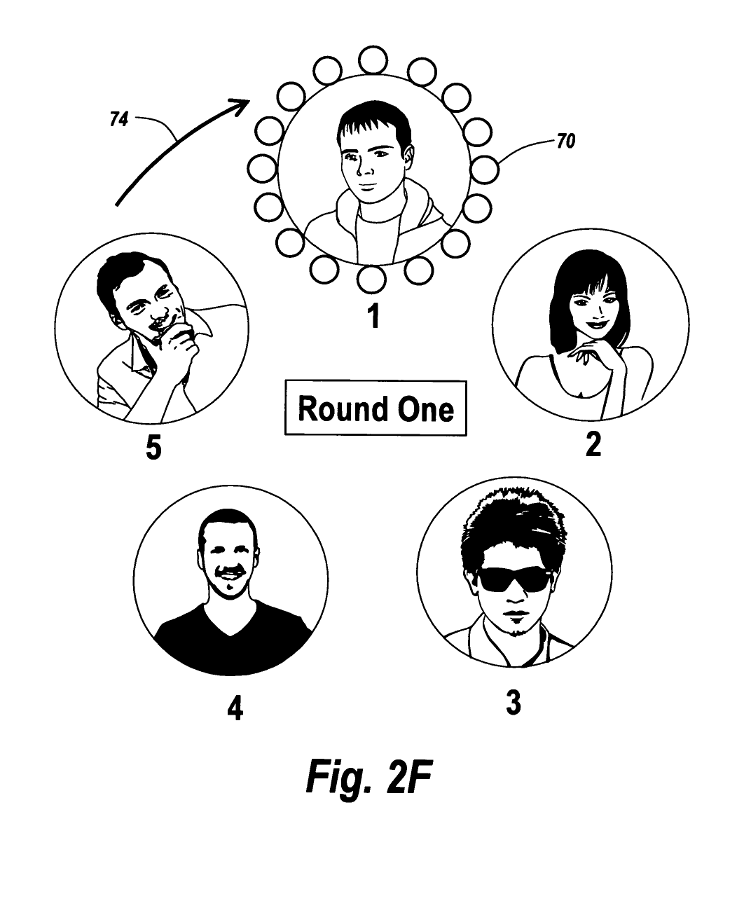

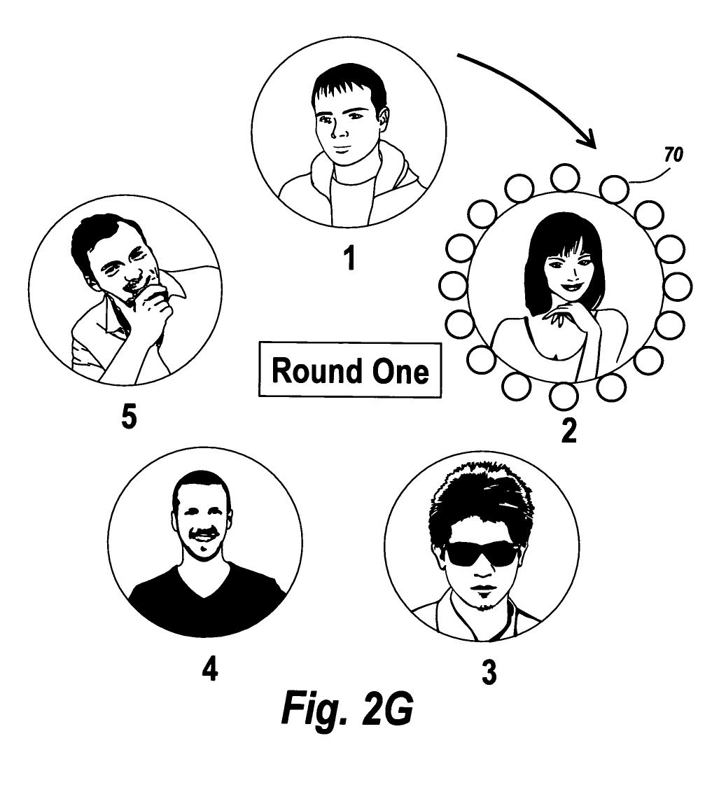

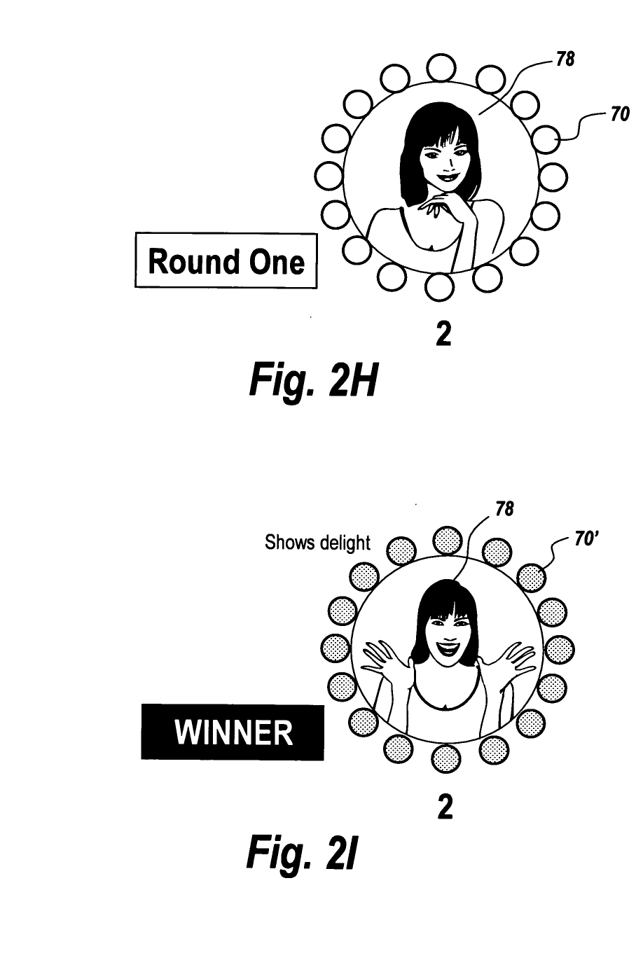

For instance, and referring now to FIG. 2A, if the windows are for instance labeled 1, 2, 3, 4 and 5, here corresponding to windows 34, 36, 38, 40 and 42, at the outset of the game each of the participants selects a particular window for the particular round. For instance if there are three rounds leading to the winning of the jackpot, then each of the participants may select the same window for each of the rounds or a different window for each of the rounds. For instance, an individual participant may select 1, 3, 2 such that in order to win the jackpot the selected window must be windows 1, then 3, then 2, with window selection being the result of the winning selection algorithm.

As shown in FIG. 2A, window 1 is first selected as illustrated by indicia 70 surrounding the image of the participant who has selected 1. Thereafter as illustrated in FIG. 2B at arrow 74 the window selection algorithm moves to window 2, with the indicia 70 being supplied to indicate the selected window.

The same is true for FIG. 2C in which window 3 is selected, as well as in FIG. 2D where window 4 is selected. Here participant or player 76 indicates as her window is selected unbridled anticipation such that when the selection process stops hopefully for her, her window will be the one that is selected.

Likewise as illustrated in FIG. 2E window 5 is selected as indicated by indicia 70, whereas in FIG. 2F window 1 is again selected as indicated by indicia 70, with the selection process in one embodiment being sequential selection of windows as indicated by arrow 74. Again as illustrated in FIG. 2G window 2 is selected as illustrated by indicia 70.

Whether music is used or whether the system is music-less, at a preselected time the selection process stops on window 2 with the indicia indicating that the participant who selected window 2 has won the particular round.

As shown in FIG. 2H immediately preceding the announcement that window 2 has been selected, the image 78 continuing the live feed of the individual who has selected window 2 is shown. Thereafter, as shown in FIG. 2I, for window 2 the reaction of individual 78 upon being apprised of winning is shown in which the individual shows delight or other type of positive emotion. Here the winner is shown by the change of the indicia 70 to indicia 70′ indicating the selection of that particular window. Concurrently the individual's live feed appears at the window when the winner window selection is made.

In one embodiment of the subject invention upon the commencement of the first round music is played such that at a particular preselected time the music stops indicating which of the windows has been selected and thus who is the winner of the round, namely the individual being filmed at the time that the window is selected. The timing of the stoppage of the music and thus the selection of the window may be chosen at random utilizing a random number generator. Alternatively, any manner of selecting a window may be utilized, with the window selection not necessarily needing to be sequential as shown. For instance, the selection may jump from one window to another without apparent indication of which direction the selection process is going, it only being necessary to show the video feed of the winning individual when his or her particular window has been selected.

Round 2 continues in the same way as round 1 with the participants not necessarily choosing the same window as that of round 1. Here it is shown that individual 44 is the same individual who selected window 1 in round 1. However, individual 46 is an individual who while playing in round 1 was not selected to have his video feed shown. Here individual 48 has chosen window 3. Note that there is a different player 50 for window 4, with player 78 who won the first round having now selected window 5, as opposed to window 2 for the first round.

It will be appreciated that there can be different people for round 2 as opposed to round 1 if for instance there are more than one participant selecting a given window. In one embodiment of the subject invention there may be as many as 100 participants for each of the windows which increase the number of players who can participate in the game. Therefore, for purposes of the present discussion it is assumed that the individual 46 and the individual 50 are different from the ones pictured for round 1, although they have registered for the windows at the start of the lottery contest.

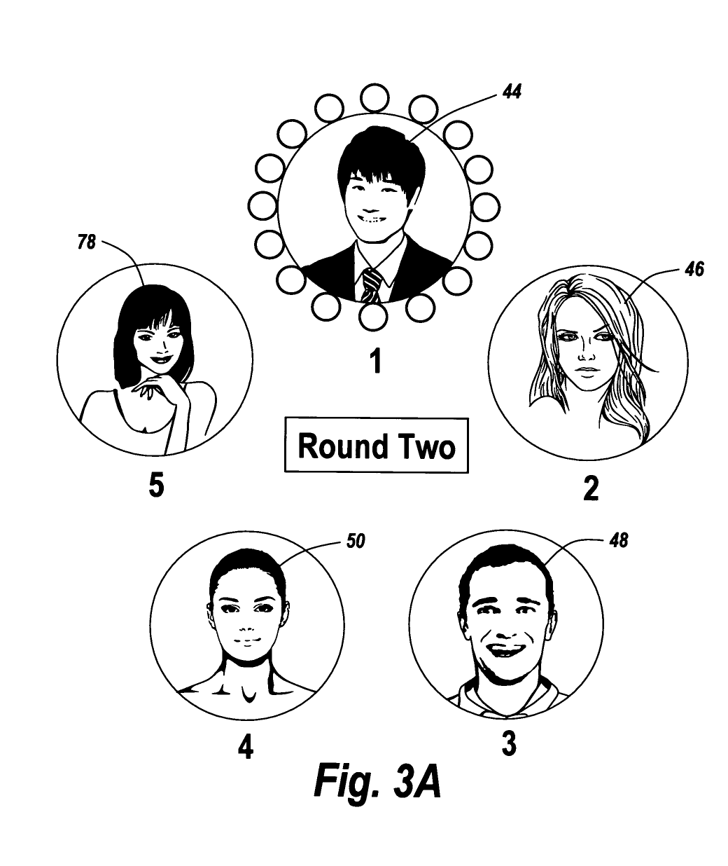

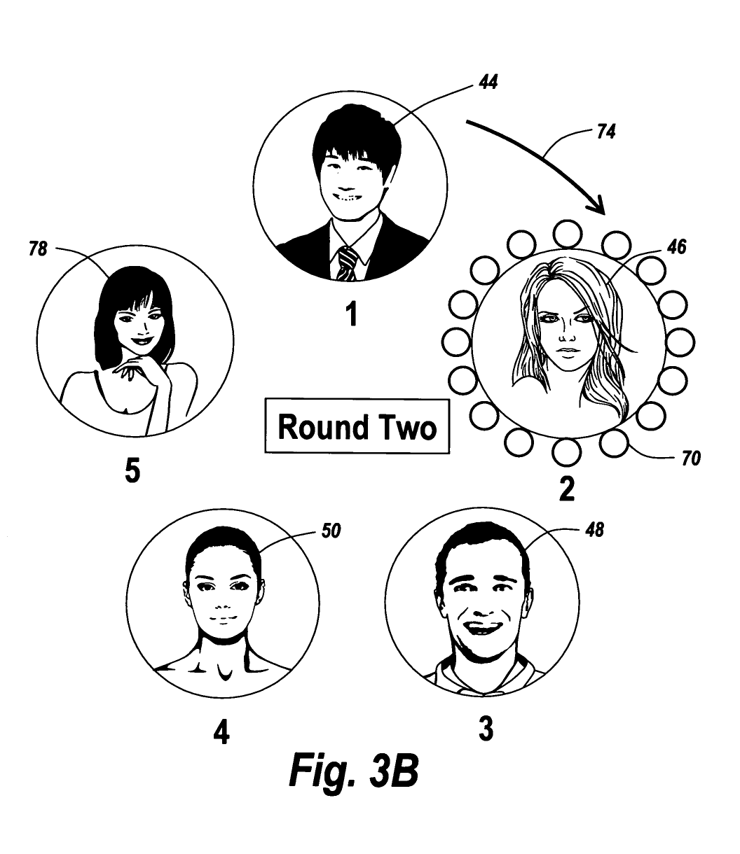

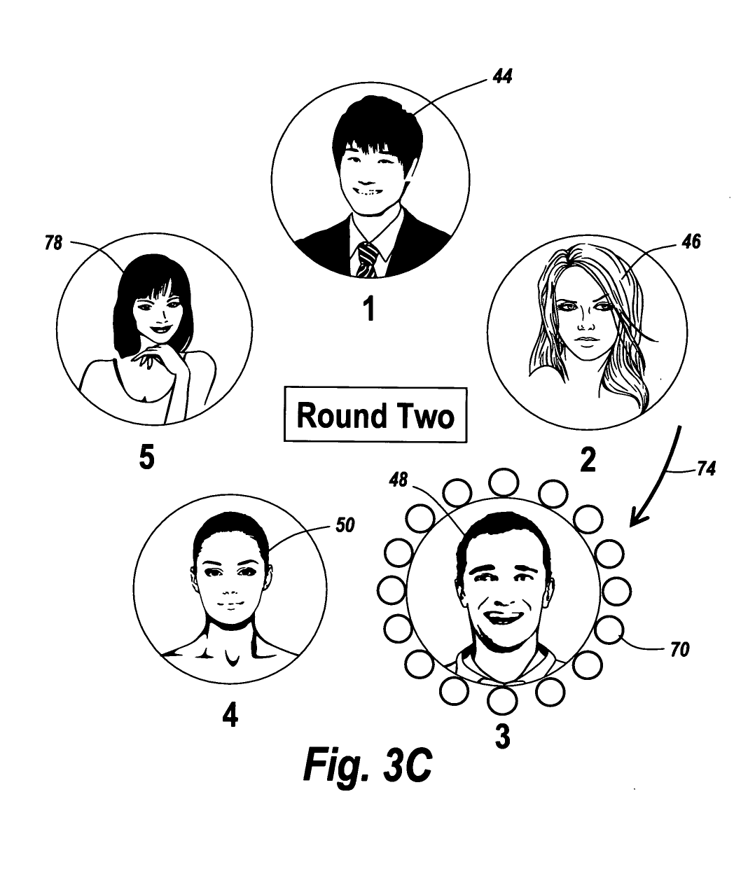

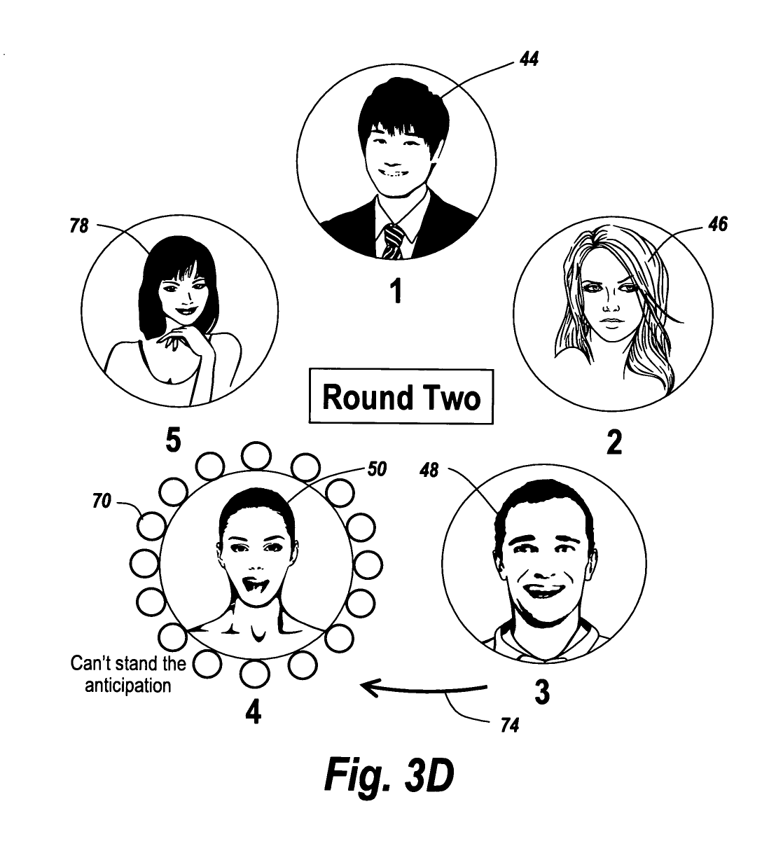

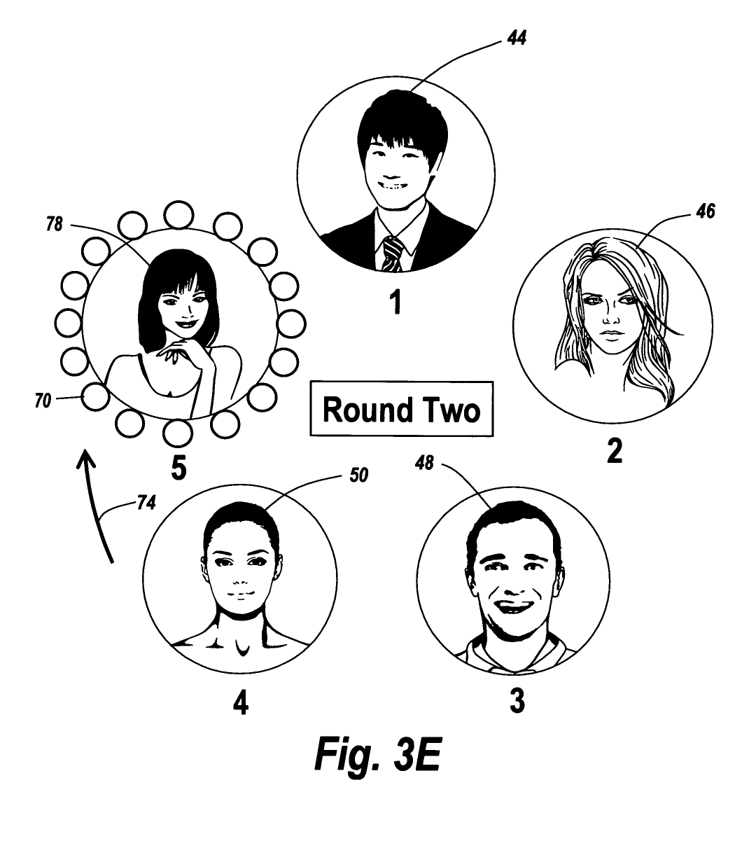

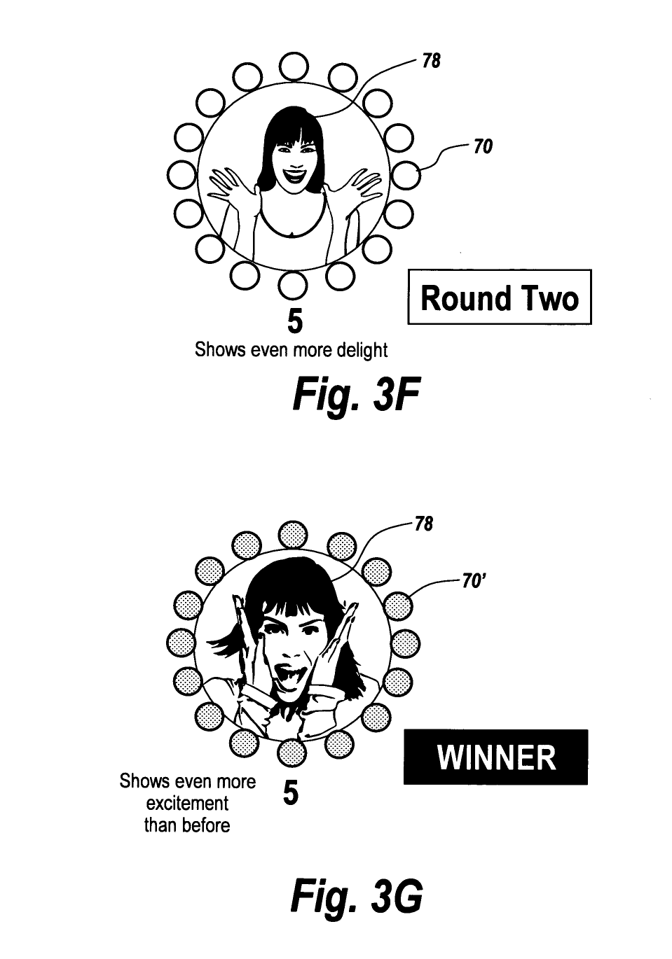

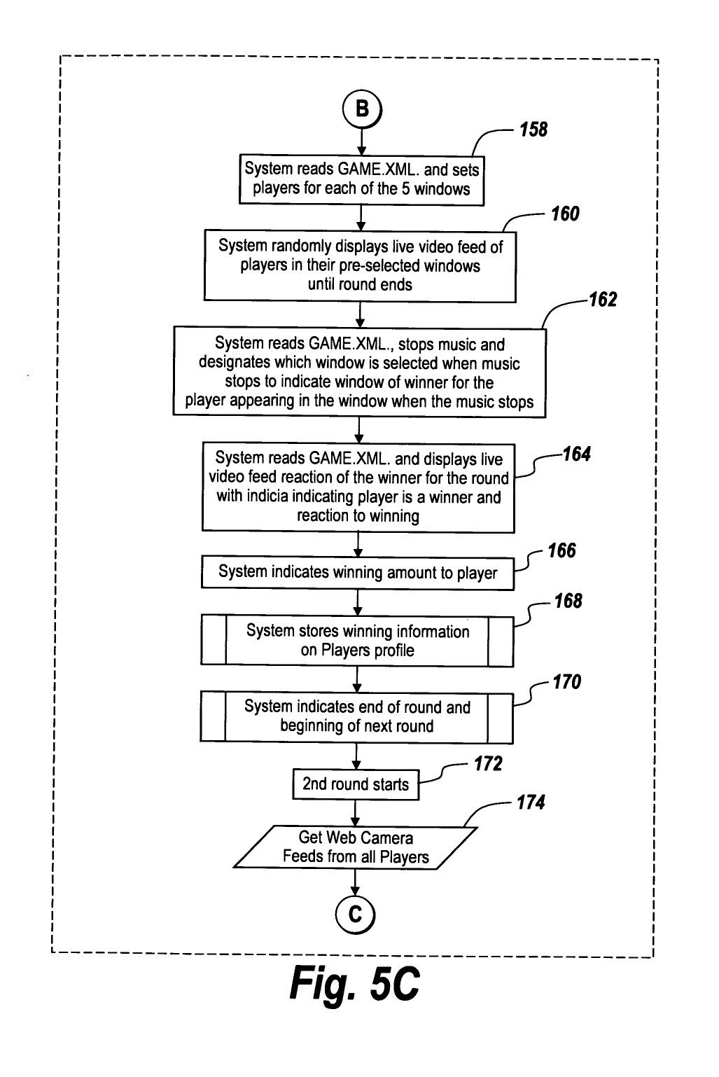

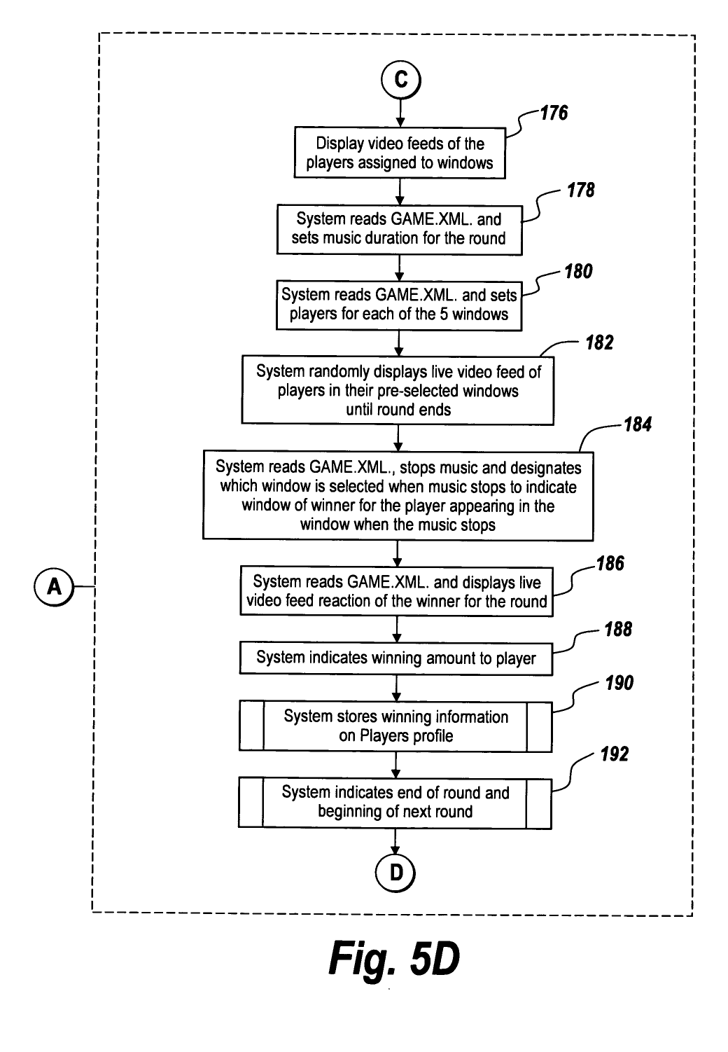

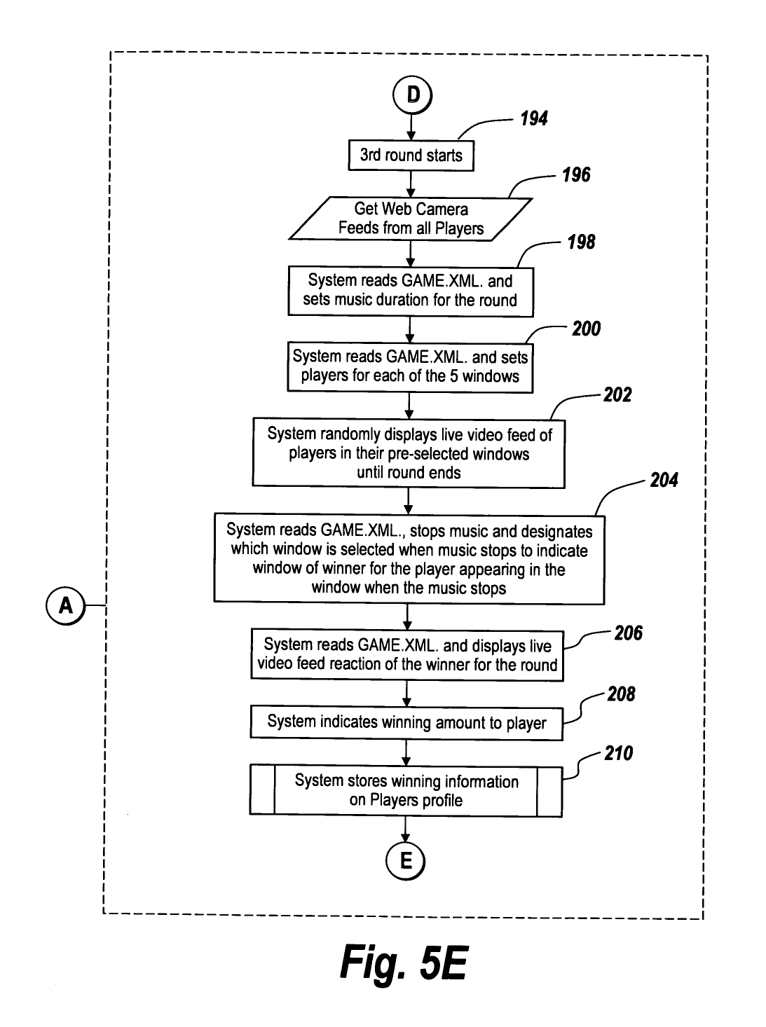

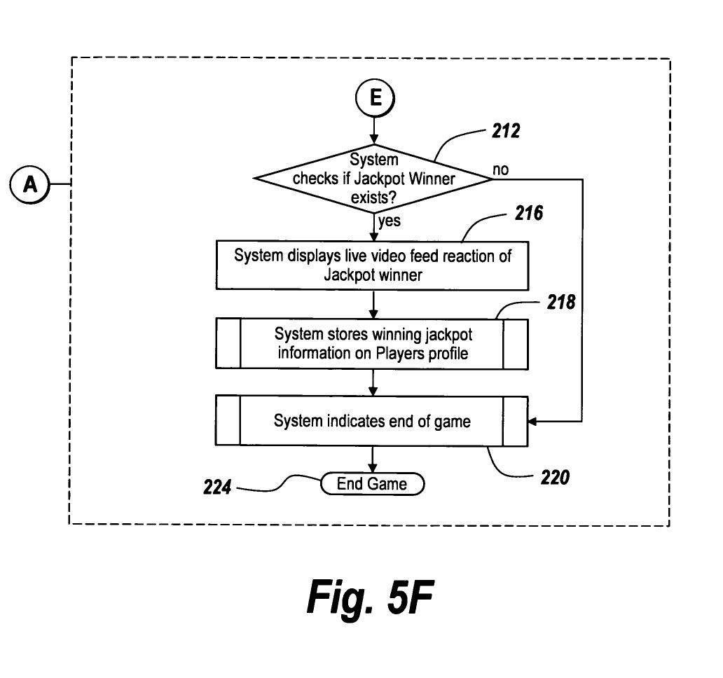

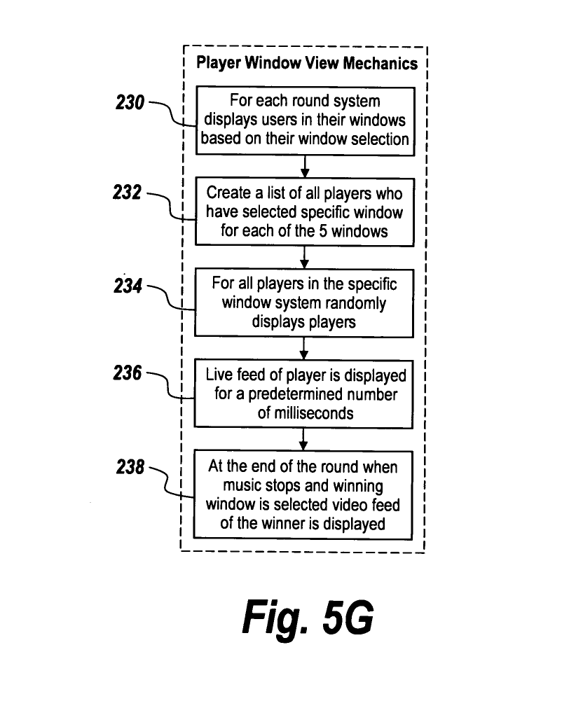

As shown in FIGS. 3B-3G the window selection process is the same as shown in round 1 with the exception that window 5 is the window selected by the system as being the winning window. Here it can be seen that the same participant 78 has been selected as the winner of the second round. As indicated in FIG. 3F just prior to the selection of the winning window the reaction of the anticipation of individual 78 is shown. Thereafter when the final window is selected the joy of winning is transmitted to all participants as shown at 75′ in FIG. 5G.

In this case individual 78 having known that she has won round 2 has even more excitement when she finds out that she has won the second round, making her even closer to winning the jackpot

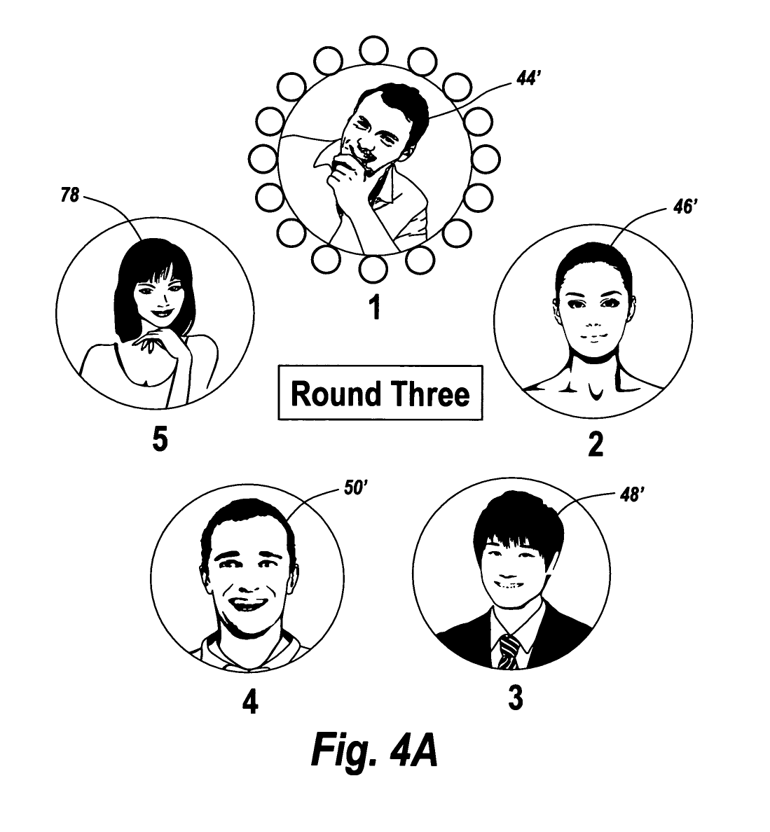

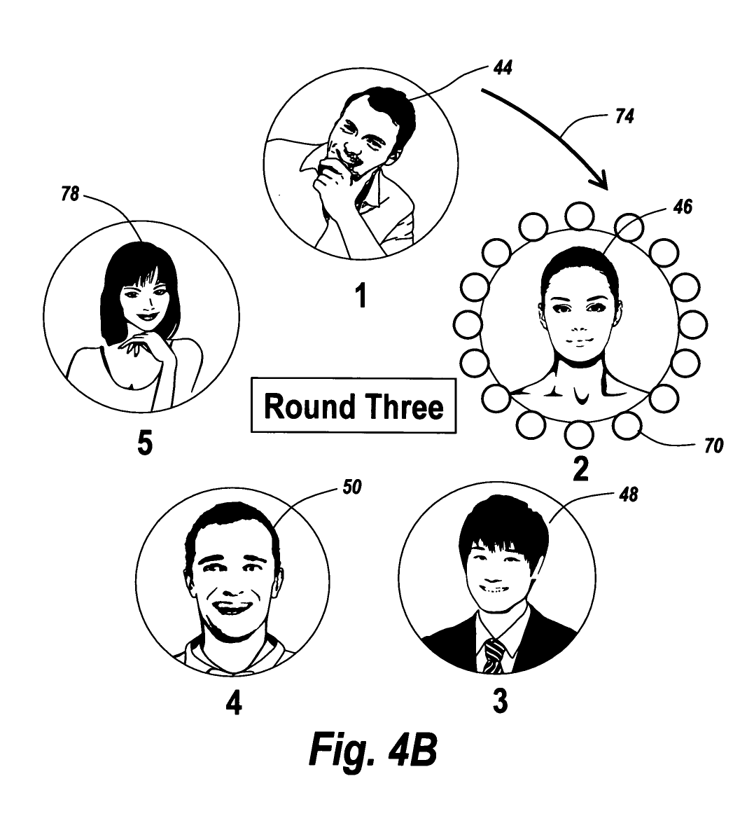

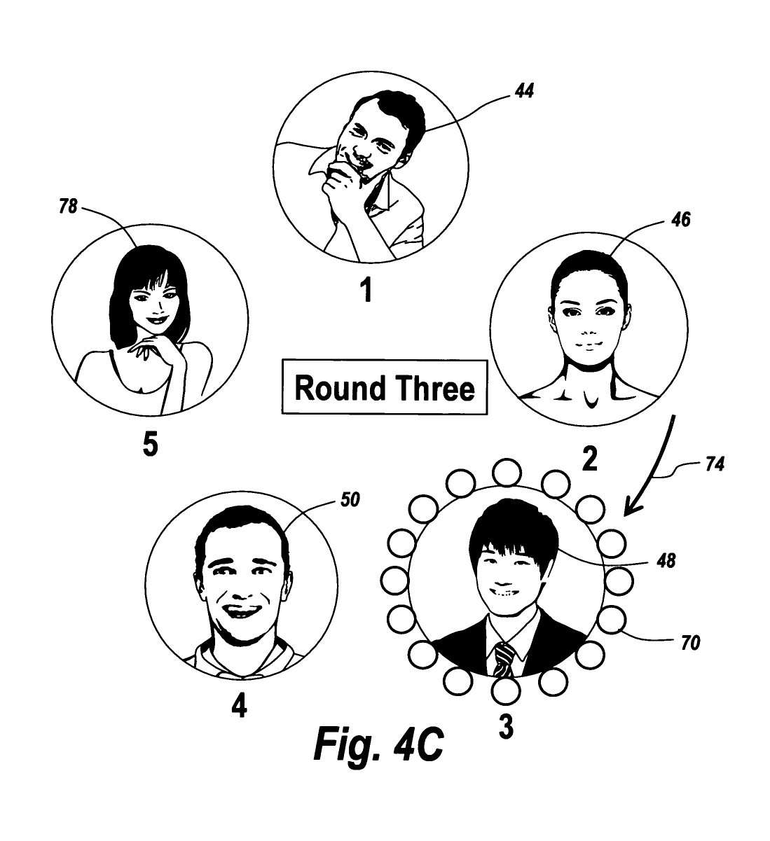

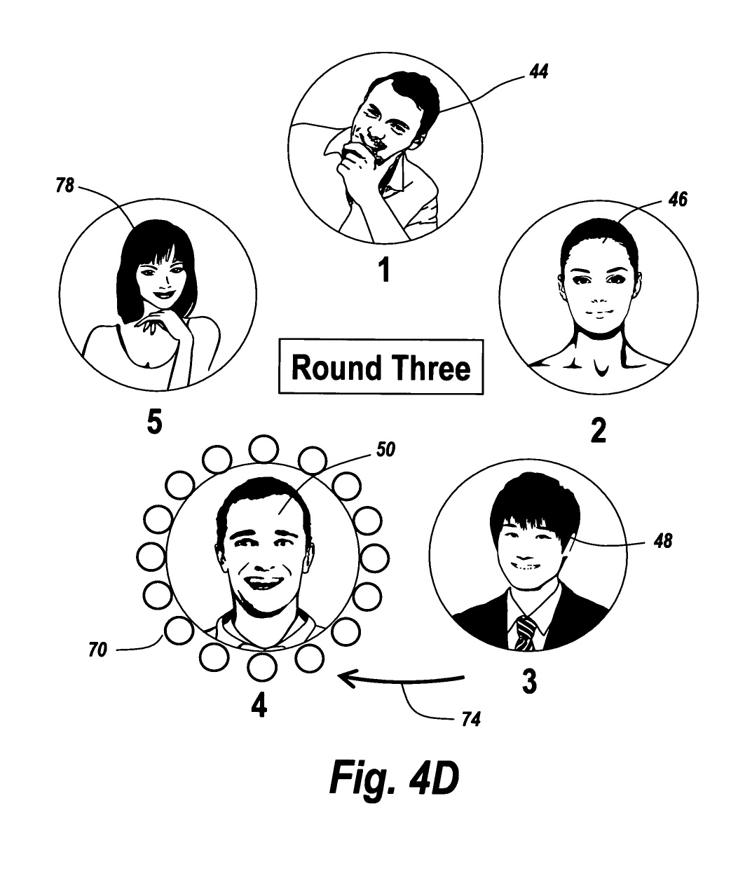

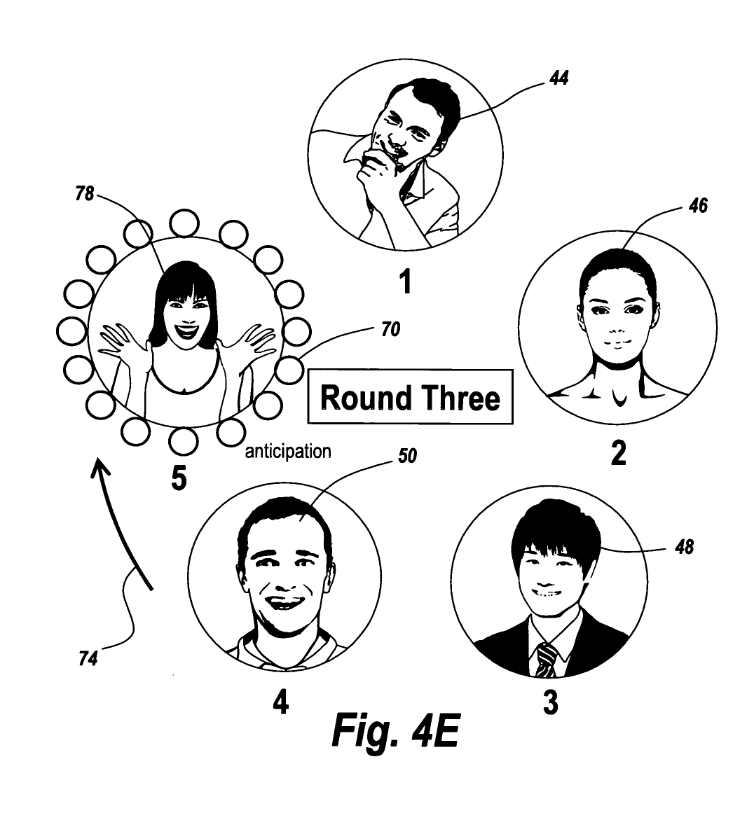

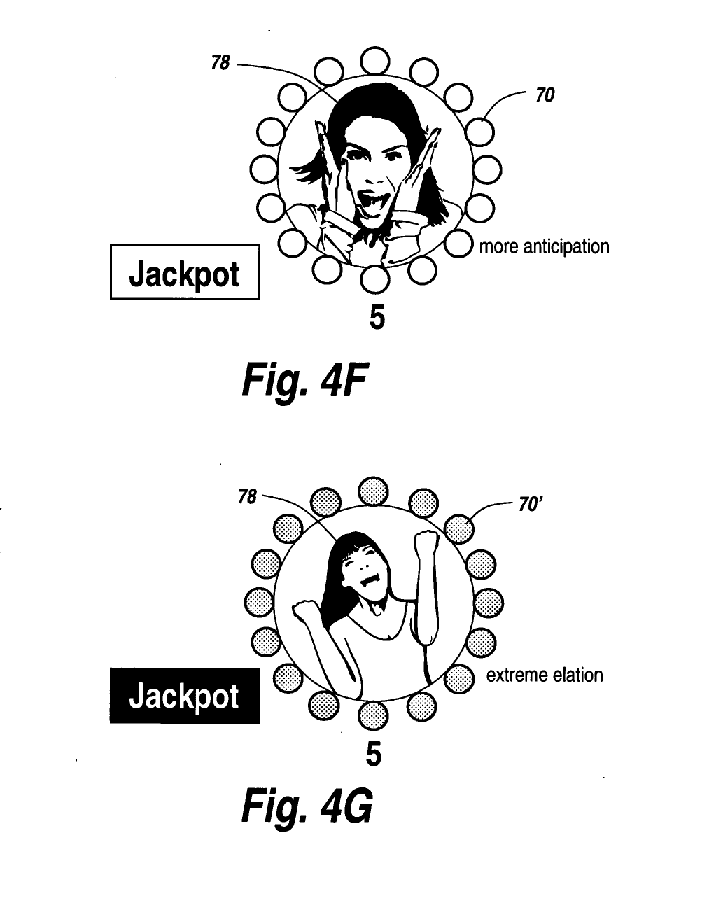

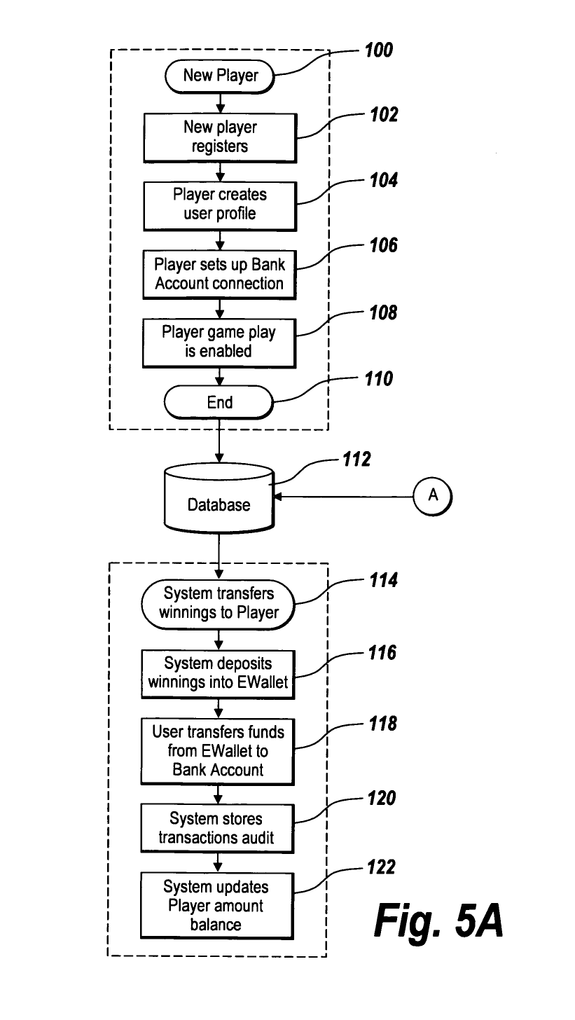

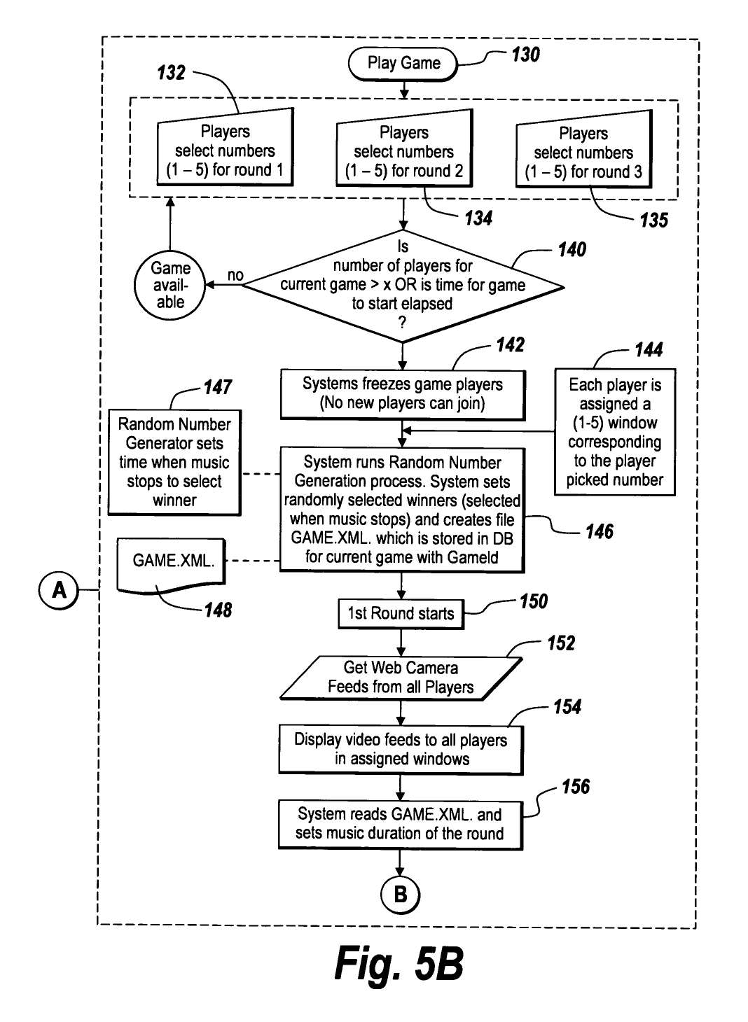

Referring now to FIG. 4A, it can be seen that participant 78 has chosen window 5 with different participants pictured in the remainder of the windows with the exception of window 2 which is now chosen by participant 50. Here it can be seen that participant 44 is newly presented in the corresponding window and is therefore labeled 44′ whereas participant 50 has now selected window 2 and whereas participant 48 is newly presented and is designated 48′. Participant 50 is newly presented and is now indicated by 50′. As illustrated participant 78 has now selected window 5 for the third and final jackpot round. FIGS. 4B-4G show the selection process such that as illustrated at 4G participant 78 is shown to be the winner of the jackpot as her window 5 has been selected. This is shown at 70 with the winning of the jackpot shown by the change of indicia 70 to indicia 70′ followed by participant 78's extreme elation shown in FIG. 4I.

What is now described is a series of flowcharts describing one embodiment of the subject invention.

Referring now to FIG. 5A, as can be seen, a new player 100 registers as shown at 102, with the player creating a user profile 104 and with the player setting up a bank account connection 106 followed by the enabling of the game as seen at 108 and this portion of the flowchart process ends as illustrated at 110. Thereafter all data is stored in a database 112.

After a player has won, from database 112 the system transfers winnings to the player as illustrated at 114, followed by depositing the winnings into the player's e-wallet as shown at 116, whereupon user funds are transferred from the e-wallet to the player's bank account as shown at 118. Thereafter the above system stores the transactions in an audit trail 120 and the system updates the player account balances as shown at 122.

Referring now to FIG. 5B, in terms of game play as illustrated at 130 upon activation of a game play icon, players 132, 134 and 136 select numbers corresponding to the windows in which the player is to be displayed. Here the players select windows 1 through 5 for round 1, 1 through 5 for round 2 and 1 through 5 for round 3. As shown at 140, after the selection of the windows there is a query as whether the number of players for the current game exceeds a predetermined number or whether the time for the game to start has lapsed. Thereafter the system freezes the game players as illustrated at 142 so that no new players can join. As shown at 144 each player is assigned a window corresponding to the player-picked number. Thereafter as illustrated at 146 the system runs a random number generation process 147 to randomly select a winner by stopping the music playing during the playing of a round. The random selection of the time when the music stops thus randomly selects the winner and creates a file GAME.XML which is stored in the database 112 of FIG. 5A. In FIG. 5B this file is shown at 148. After the random number generation process has selected the first round winner, his game starts as illustrated at 150 with a process step 152 including obtaining web camera feeds from all of the players followed by the display of the video feeds from all of the players, each in the assigned window for the player as illustrated at 154.

Thereafter, as illustrated at 156 the system reads the GAME.XML file and sets the music duration for the particular round. It will be appreciated that the music duration for the particular round is predetermined in terms of where the music stops to select the winner. Thus, for each round the duration of the music specifies the winner for the particular round.

Referring to FIG. 5C, as illustrated at 158 the system reads the GAME.XML file 148 and sets the players for each of the 5 windows, thereby assigning a player to a particular window.

As illustrated at 160 the system randomly displays the live video feed of the players in their corresponding windows until the round ends. If for instance there will be more than one player to be assigned to a particular window, the system at this point randomly and sequentially displays the video feed from a player in a particular time slot for the selected window and displays the video feed for a predetermined number of milliseconds until the round ends. In this manner the number of players that can play in a given round is multiplied by the number of players that are allowed to select a window.

Then as shown at 162 the system reads the GAME.XML file and stops the music. At that point a window is selected to indicate the winner, such when the music stops the selected window contains the image of the winner.

As illustrated at 164 the system again reads the GAME.XML file and displays the live video feed reaction of the winner of the round, with indicia indicating the winning player and the reaction to the winning.

As illustrated at 166 the system indicates the winning amount to the player, after which the system stores the winning information on the player's profile as illustrated at 168, followed by indicating the end of the round. This starts the beginning of the next round as illustrated at 170.

As illustrated at 172 the second round starts which is followed by obtaining of the web camera feeds from all the players as illustrated at 174. Referring to FIG. 5D, at 176 the video feeds from all the players are displayed each in the assigned window. Thereafter, as illustrated 178 the system reads the GAME.XML and sets the music duration for the current round. As illustrated at 180 the system reads the GAME.XML file and sets the players for each of the 5 windows. As seen at 182 the system randomly displays the live video feed of the players in their pre-selected windows. As before, if there are more players than one for each window, the players for each window are randomly displayed for a predetermined number of milliseconds until the round ends.

As shown at 184, the system reads the GAME.XML file and stops the music and designates which window is selected when the music stops to indicate the window of the winner of the player appearing in the window when the music stops.

Thereafter as illustrated at 186 the system reads the GAME.XML file and displays live video feed reaction of the winner of the round, followed as illustrated at 188 indicating the winning amount to the winning player, again followed by winning information being stored in the player's profile as illustrated at 190. As illustrated at 192 the system indicates the end of the round and the beginning of the next round, whereas in FIG. 5E at 194 the third round starts.

As shown at 196 again the web feeds from all of the players are obtained and the system reads the GAME.XML file and sets the music duration for the current round as illustrated at 198. As illustrated at 200 the system reads the GAME.XML file and sets the players for each of the 5 windows. Thereafter as illustrated at 202 the system displays the live video feed of the players in their pre-selected windows until the round ends, it being noted that multiple players for a window will be handled in the same way as previously described.

As illustrated at 204 the system reads the GAME.XML file and stops the music and designates which window is selected when the music stops to indicate the window of the winner for the player when the music stops. Thereafter as illustrated at 206 the system the GAME.XML file and displays the live video feed reaction of the winner for the round.

As illustrated at 208 the system indicates the winning amount to the player and stores the winning amount in the player's profile as illustrated at 210.

As described in FIG. 5F, this is followed by a decision block 212 which ascertains if a jackpot winner exists. If there is no jackpot winner then the system ends the game as illustrated at 220, with the game ending as illustrated at 224.

On the other hand, if there is a jackpot winner as illustrated at 216 the system displays live video feed of the jackpot winner, with the system storing the winning jackpot information in the player's profile as illustrated at 218.

In this particular embodiment of the game, a player must select the winning window in each of the three rounds. If there is no one player that selects the winning window in each of the three rounds then there will be no jackpot winner. On the other hand, if one player selects the correct winning window in each of the three rounds, then this player is declared the jackpot winner.

Referring now to FIG. 5F, the player slot view mechanics are described in which live video files are stacked ready for display on a multiplexed basis. Here as can be seen at 230 for each round the system displays the player in their slots or windows based on their window selection. As illustrated at 232 a list is created of all of the players who have selected a specific window for each of the 5 windows.

As illustrated at 234 for all the players in a window, the system randomly displays the players in that window. As illustrated at 236 the live feed of the player is displayed for a predetermined number of milliseconds, thus to be able to cycle through the individuals whose feeds will be displayed in a given window.

As shown at 238 at the end of the round when the music stops and the winning window is selected, the video feed of that particular winner that appears in the window at the time the music stops is highlighted and displayed. It is in this manner that the game can be expanded to include more players such that each window may be selected by multiple players whose video feeds are multiplexed or selected, either randomly or in sequential order to be displayed in the window.

When the music stops and the window is indicated as the winning window, then it is the player who is displayed at that particular moment in time who becomes the winner.

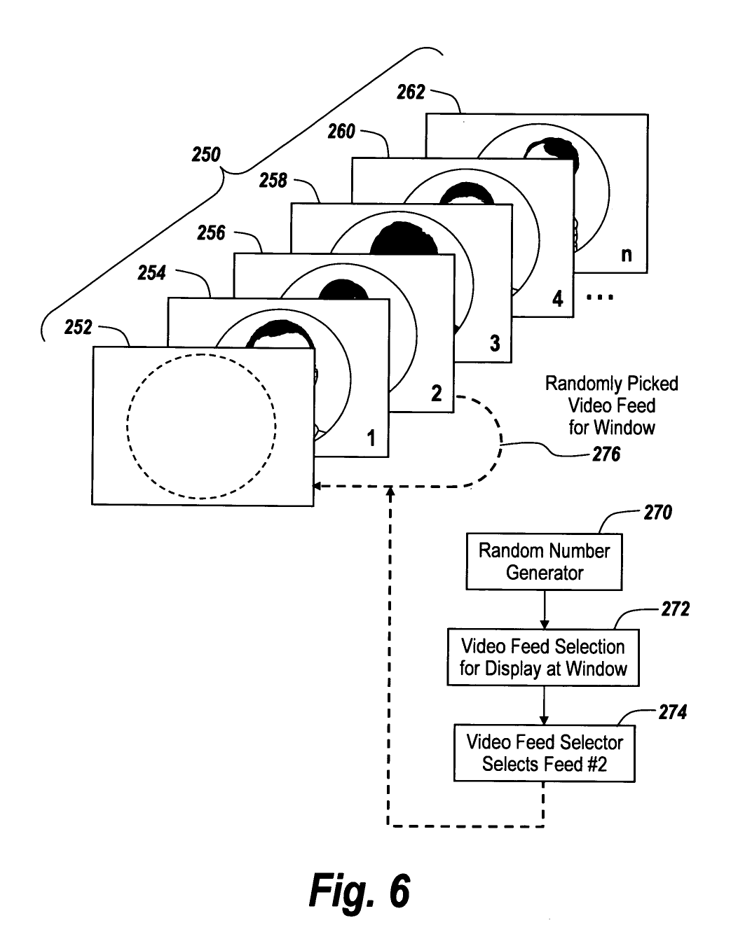

Referring now to FIG. 6, the random presentation of images in a particular window is discussed. Here a number of images from live streaming videos are stacked as illustrated at 250 to be presented at a window 252. Here the stacked images labeled 1, 2, 3, 4 . . . n are shown as they would be displayed. The individual live video streams are shown at 254, 256, 258, 260 . . . 262.

As will be appreciated in the subject system if more than one participant or player chooses a given window, then a multiplexing system must be provided so that the individual live streaming video from different participants can be selected for display in the window at different times.

When viewing the window an observer will see the live streaming image of first one participant, then another and then another, with the persistence of the images on the screen on the order of milliseconds. This permits the live streaming images to be presented on-screen in the window one at a time.

The ordering can be sequential or can be random. In the preferred embodiment a random number generator 270 is utilized to drive a video feed selection unit 272 for selecting which of the feeds for the window is to be displayed in the window.

The video feed selection unit 272 is coupled to a video feed selector 274, which in the illustrated embodiment selects the second of the stacked video feeds 256 and displays it at window 252 as illustrated by dotted arrow 276.

During game play participants for a given round select which window they would like their video feed displayed in. Since the window has video feeds cycled as indicated above, when the system selects a window and thus a winner, the winner is a participant whose live video feed appears in the window at the exact moment of the selection.

In one embodiment when selection is based on the stoppage of music, the live video of the participant whose video is being displayed in the window when the music stops is designated the winner.

This in the case where multiple participants select the same window, in one embodiment of the subject invention the above identified random selection process is used.

It will be appreciated that with a large number of participants the winning of the lottery not only depends upon a participant selecting a winning window, it also depends on whether or not the individual's live feed is presented at the window at the time the window is selected. This decreases the probability of a win by a factor depending on the number of participants selecting the window, as well as the time allotted for each presentation.

As will be appreciated, the administrator of the game has the ability to choose different game types namely the number of windows such that the number of windows can be for instance 5 windows, 16 windows or 25 windows. The system can also calculate the payout amount based on the size of the jackpot. The administrator can configure the duration of the time the player appears in any given window, whereas the system can select player feeds to be displayed in their windows based on time constraints and the number of players.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A system for increasing interest in an Internet based lottery in which participants are connected by the internet to a central server, the server adapted to notify a participant over the Internet that the participant has won the lottery and adapted to present winner reaction to all lottery participants by means of a live Internet video feed of video of the notified winner to all lottery participants.

2. In an Internet based lottery system, a central server adapted to be connected to the Internet and adapted to receive live streaming video from a plurality of participants in the internet based lottery, said server selecting a lottery winner and adapted to transmit to a participant over the Internet notification that the participant has won the lottery, said server adapted to receive live video from the winning participant, and adapted to provide live video of the winning participant to all lottery participants, thus to create excitement for playing the lottery game.

3. The system of claim 2, wherein said server allocates a number of windows in the display of each of the computers utilized by the participants, each of said windows including a live video of a participant, whereby each participant can view the video of each of the other participants as well as himself in a window assigned to a participant in the beginning of a lottery round.

4. The system of claim 3, wherein the notification that a participant has won the lottery is transmitted over the Internet to the computer associated with the winning participant, with indicia at the window containing the winning participant's video indicating to the participant that the participant has won.

5. The system of claim 4, wherein said server includes a module for selecting said windows on a sequential basis such that during the playing of the lottery game only a participant that appears in a selected window will be eligible for winning.

6. The system of claim 5, wherein said server selects a window in accordance with a number from a random number generator.

7. The system of claim 6, wherein said server includes a module for playing music during a lottery round, the music being transmitted to each of the participants over the Internet, said server selecting a lottery winner when during the lottery round the music stops.

8. The system of claim 7, wherein the stoppage of the music is governed by a number from a random number generator.

9. The system of claim 3, wherein at the beginning of a lottery round, each participant selects a window in which the participant's video is to appear.

10. The system of claim 9, wherein for at least one window multiple participants select said at least one window and wherein said server cycles the video from the participants selecting said at least one window such that the video from only one participant appears in a window at one time.

11. The system of claim 10, wherein for a window having multiple participants, the winning participant is that participant having the participant's video presented in the window when the window is selected and when notification of a winner is transmitted to the selected window.

12. The system of claim 3, wherein said server provides notification indicia to the windows to indicate which of the windows is selected.

13. The system of claim 12, wherein said server can only designate a winner in a selected window.

14. The system of claim 13, wherein the server provides a notification of a winner in a selected window only for a participant whose video is presented in the selected window at the time of notification.

15. The system of claim 14, wherein the selection of the windows is based upon the number generated from a random number generator.

16. The system of claim 15, wherein for a window having multiple participants, the participant whose video is presented in the window is governed by the number from a second random number generator.

17. The system of claim 3, wherein the winner of a lottery round is that participant whose video is presented in a window that has been selected at the time that notification is transmitted to the selected window.

18. The system of claim 3, wherein notification that a participant has won the lottery round occurs when music generated for the lottery round stops.

19. The system of claim 18, wherein said server provides a notification of the winning participant at the time that the music stops by generating an icon at the winning window when said music stops.

20. The system of claim 19, wherein windows are selected in accordance with a randomly generated number and wherein notification of a winning participant is only provided in the window selected by the random generated number.
